(19) United States
(12) Patent Application Publication
(10) Pub. No.: US 2009/0021668 A1
(43) Pub. Date: Jan. 22, 2009

(54) Backlight Module and Liquid Crystal Display Comprising the Same

(75) Inventors: Wen-Yuan Cheng, Hsinchu (TW); Cheng-Chih Lai, Hsinchu (TW); Keng-Ju Liu, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/941,507

(22) Filed: Nov. 16, 2007

(30) Foreign Application Priority Data
Jul. 16, 2007 (TW) 96125864

(51) Int. Cl. G02F 1/1335; F21V 7/04

(52) U.S. Cl. 349/65; 362/620

(57) ABSTRACT

A backlight module and a liquid crystal display including the backlight module are provided. The backlight module includes a light source, a light guide plate and a prism sheet. The light source is disposed at a side of the light guide plate, while the prism sheet is disposed adjacent to the light emitting surface of the light guide plate. The prism sheet has a plurality of prism structures facing the light guide plate, wherein each of the prism structures substantially has a vertex angle of about 55 to 70 degrees. Thus, light emitted from the light guide plate can be adjustably concentrated along the direction perpendicular to the panel.

This application claims the benefits of the priority based on Taiwan Patent Application No. 096125864 filed on Jul. 16, 2007; the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a backlight module for use in a liquid crystal display. In particular, the present invention relates to a backlight module that demonstrates a superior light collecting performance, and a liquid crystal display comprising the backlight module.

2. Descriptions of the Related Art

With low power consumption, light weight, low radiation intensity and good portability, liquid crystal displays (LCDs) have been widely used in TV sets, computer screens, laptops, vehicle navigation systems and mobile communication devices, among others. LCDs have replaced conventional displays and have become the mainstream product in the display market. As one of the key components in LCDs, the backlight module is responsible for providing uniform and sufficient light to the LCD panel, and is mainly composed of a light source, a light guide plate, a prism sheet, a diffusion sheet, a reflective sheet, and an optical film.

The backlight modules are classified primarily into two types according to the location of the light source: direct or edge. In the edge type backlight module, the light source is disposed on the edge of the light guide plate. Such an arrangement has a slim overall profile, and can also satisfy many of the backlight module's necessities, such as high luminance, low cost and uniform brightness. For these reasons, the edge type backlight module is more commonly used, especially in LCDs with specific sizes.

A schematic view of a conventional edge type backlight module is depicted in FIG. 1A. The backlight module 10 is mainly comprised of a light source 11, a light guide plate 13 and a prism sheet 15. Light generated from the light source 11 gets into the light guide plate 13 through an edge 131 thereof, and the light is emitted from the light-emitting surface 135. On the bottom surface 133 of the light guide plate 13, a plurality of fly-cut patterns 17 are formed. Each of the fly-cut patterns 17 has a semi-pit shape configured by a principal axis and a secondary axis to eliminate the total reflection inside the light guide plate 13. In other words, the denser fly-cut patterns 17 will result in less total reflection of light inside the light guide plate 13, and thus, the light will be refracted out of the light guide plate 13 more easily. On the other hand, the sparser fly-cut patterns 17 will result in a higher possibility of total reflection on the bottom surface of the light guide plate 13. Thus, light emitting from the light-emitting surface 135 is delayed. It is conceivable that the preferred distribution could be achieved by adjusting the arrangement direction and density of the fly-cut patterns 17, and thus, uniform light could be emitted from the light-emitting surface 135.

Upon the formation of the surface light source, a further adjustment may be made using other optical elements (e.g., a prism sheet 15 disposed on the side of the light-emitting surface 135) to obtain the preferred light condition. It can be seen that, with such a backlight module 10, light from the light source 11 can be diffused into a surface light source for use in a liquid crystal panel.

However, in view of user's habits, the user typically views the liquid display panel at a normal angle of about 90 degrees. To achieve a higher efficiency and to provide a higher luminance from a back light module 10 with a constant light source 11, light needs to be provided perpendicularly to the liquid crystal panel, preferably.

FIG. 1B illustrates a graph of luminance (in nits) of the conventional backlight module 10 as shown in FIG. 1A when measured within a viewing angle range of ±80 degrees. Assuming that the angle normal to the light-emitting surface 135 is 0 degrees, light emitted from the conventional backlight module 10 depicted in FIG. 1A tends to diffuse at various angles. It can be seen from the measurement result depicted in FIG. 1B that a majority of the light concentrates within a viewing angle range of about ±30 degrees. Given the conservation of energy from the light source, the more light is emitted from other angles, the less light will be emitted normal to the display panel (i.e., at a viewing angle of 0 degrees), which means that the conventional backlight module 10 cannot provide light to the liquid display panel at the preferred angle. As a result, the overall performance is poor.

Further, as depicted in FIG. 1A, a portion of the light projected from the light guide plate 13 onto the prism sheet 15 in the conventional backlight module 10, especially at a large diffusing angle, may result in a total reflection, causing the light to be reflected back into the light guide plate 13 rather than transmit through the prism sheet 15. This scenario is unfavorable for the overall optical performance of the backlight module 10.

In view of this, it is important to provide a backlight module that exhibits a superior light collecting effect and a liquid crystal display comprising the same.

### SUMMARY OF THE INVENTION

One objective of this invention is to provide a backlight module and a liquid crystal display (LCD) comprising the backlight module. With the structure of the present invention, light emitted from a lamp can be converted into a uniform surface light source for subsequent use in an LCD panel.

Another objective of this invention is to provide a backlight module and an LCD comprising the backlight module, in which a prism sheet is disposed on the light-emitting surface of the light guide plate. The prism sheet comprises a plurality of prism structures facing the light guide plate, each of which has a particular vertex angle. In this way, light guided by the light guide plate for diffusion will be further concentrated towards a direction normal to the display panel through the prism sheet to improve the final luminance exhibited by the LCD.

To achieve the abovementioned objectives, a backlight module is disclosed in the present invention. The backlight module comprises a light source, a light guide plate, and a prism sheet. The light guide plate has a first surface, a second surface opposite to the first surface, and a side. The prism sheet is disposed adjacent to the second surface of the light guide plate, and comprises a plurality of prism structures facing the light guide plate, each of which has a vertex angle of about 55 to 70 degrees. The present invention also discloses a liquid crystal display, which comprises a liquid display panel, and the backlight module described above. In addition, a backlight module, which comprises the prism structures described above, is further disclosed in this invention. The first surface of the light guide plate has a plurality of fly-cut patterns disposed thereon.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view illustrating a conventional backlight module;

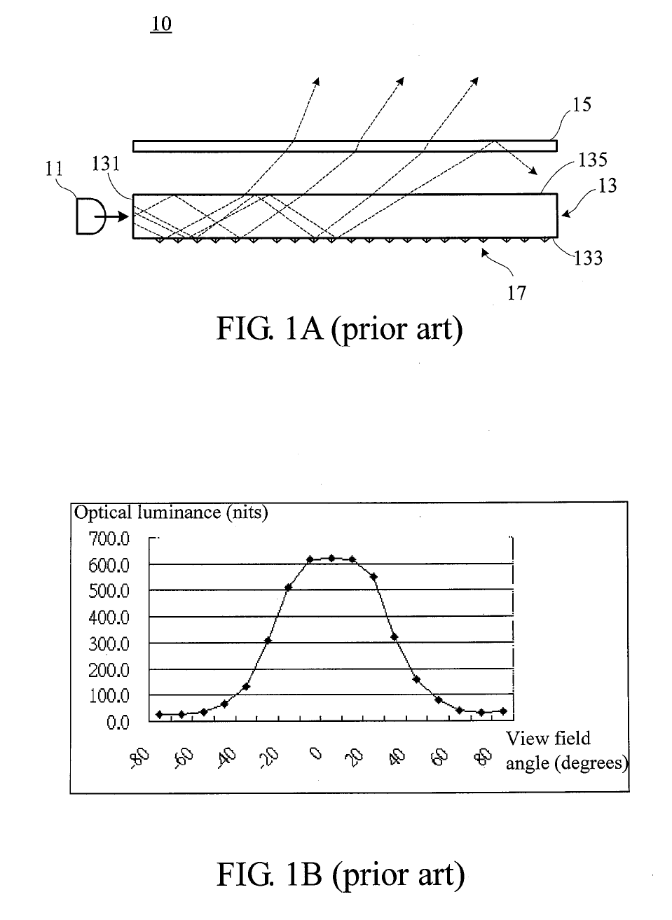

FIG. 1B is a graph illustrating the luminance of the conventional backlight module;

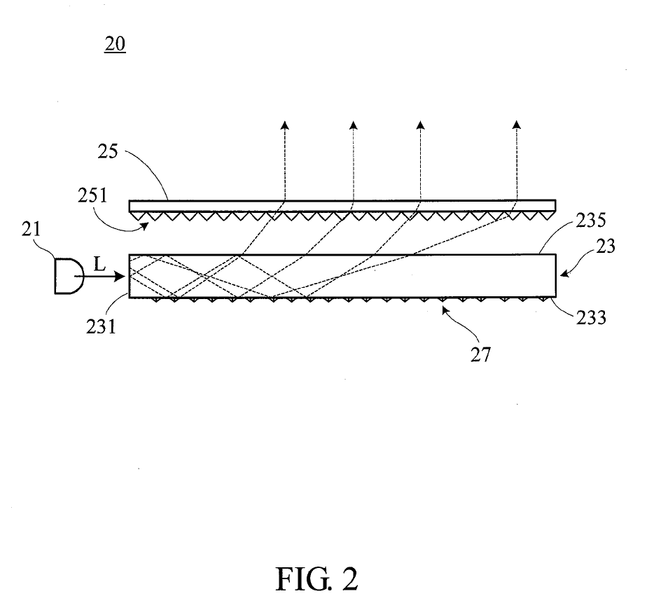

FIG. 2 is a schematic view illustrating the backlight module of one embodiment of the present invention;

FIG. 3 is a schematic plan view illustrating the light guide plate of one embodiment of the present invention;

FIG. 4A is a schematic view illustrating the fly-cut patterns on the light guide plate;

FIG. 4B is an enlarged schematic view illustrating the fly-cut patterns;

FIGS. 5A to 5E are schematic views illustrating embodiments of the prism structure of one embodiment of the present invention;

FIGS. 6A to 6C are schematic views illustrating arrangements of the prism structure of one embodiment of the present invention;

FIG. 7 is a graph illustrating the luminance of the backlight module of one embodiment of the present invention; and

FIG. 8 is a schematic view illustrating the liquid crystal display of one embodiment of the present invention.

### DESCRIPTION OF THE PREFERRED EMBODIMENT

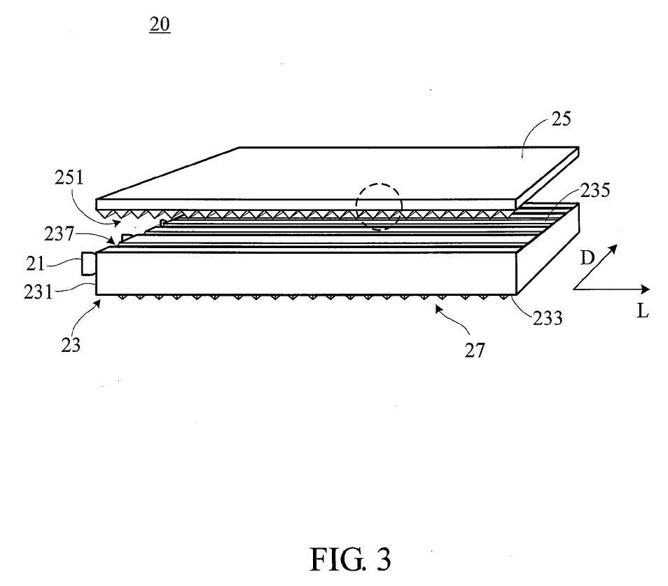

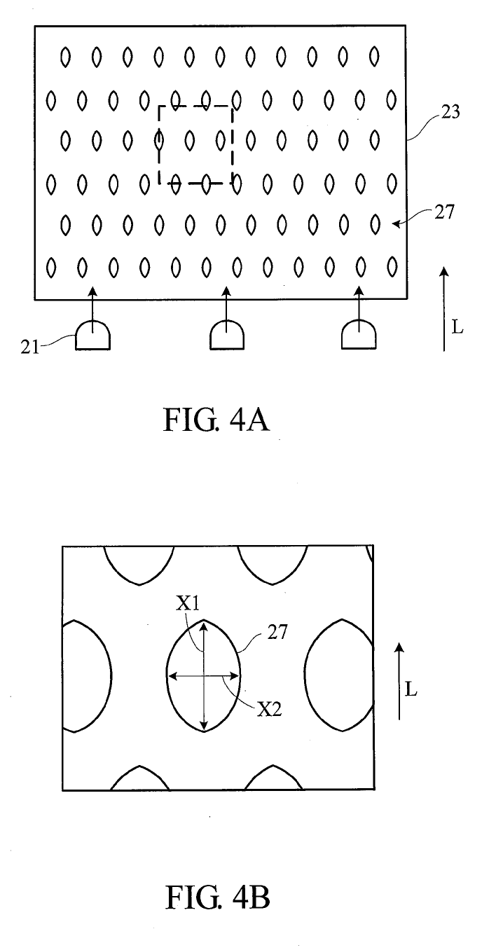

FIG. 2 and FIG. 3 illustrate a schematic view and a perspective schematic view, respectively, of the backlight module of the first embodiment of the present invention. The backlight module 20 comprises a light source 21, a light guide plate 23 and a prism sheet 25. The light source 21 may comprise at least one light emitting diode (LED), at least one cold cathode fluorescent lamp (CCFL), at least one external electrode fluorescent lamp (EEFL), or a combination thereof. However, the light source is not merely limited to those described above, and other alternative light sources will be apparent to those skilled in the art. The light guide plate 23 of the present embodiment may be defined with at least one side 231, a first surface 233, and a second surface 235 opposite to the first surface 233. The light source 21 is disposed adjacent to the side 231 of the light guide plate 23 to provide light along the light traveling direction L facing the side 231. The prism sheet 25 is disposed adjacent to the second surface 235 of the light guide plate 21.

The prism sheet 25 disclosed in the present embodiment comprises a plurality of prism structures 251, each of which has a vertex angle and faces the light guide plate 23. A reverse prism sheet is the preferred prism sheet 25 of the present embodiment.

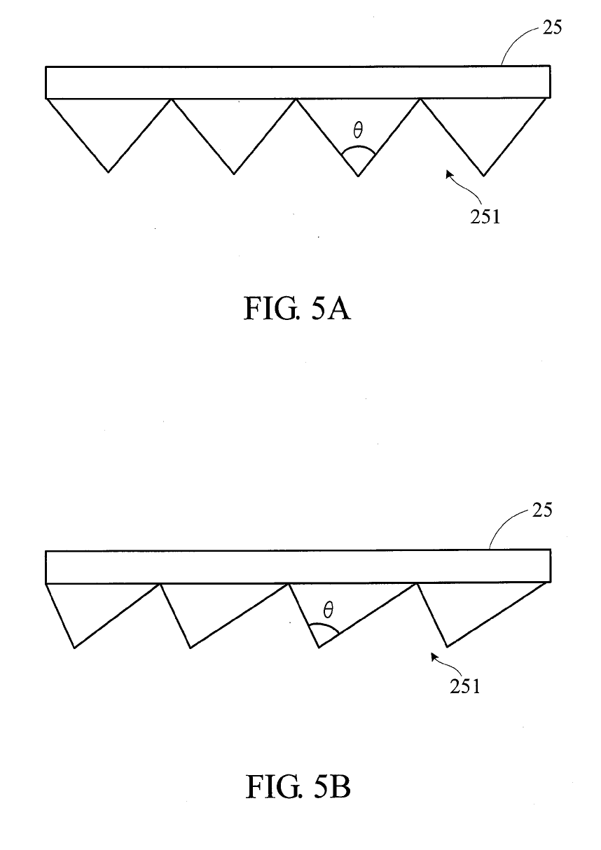

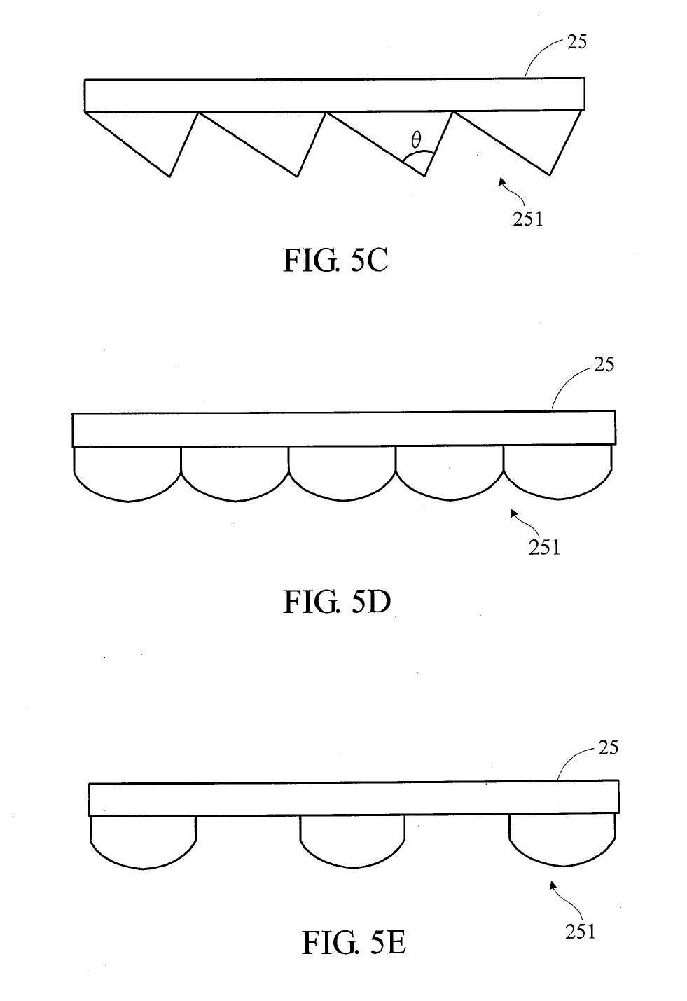

In the first embodiment of the present invention, the first surface 233 of the light guide plate 23 may have a plurality of fly-cut patterns 27 disposed thereon. FIG. 4A depicts a schematic view illustrating the first surface 233 of the light guide plate 23, while FIG. 4B depicts an enlarged schematic view illustrating the dashed-line encircled area shown in FIG. 4A. It can be seen from these figures that each of the fly-cut patterns 27 is defined with a principal axis X1 and a secondary axis X2 perpendicular to the principal axis X1. Preferably, each of the fly-cut patterns 27 should have a semi-pit shaped protrusion. In this embodiment, each of the fly-cut patterns 27 is arranged with the principal axis X1 substantially parallel to the light traveling direction L. However, the arrangement and the angle of the fly-cut patterns 27 may be optionally adjusted, and are shown here only for illustration.

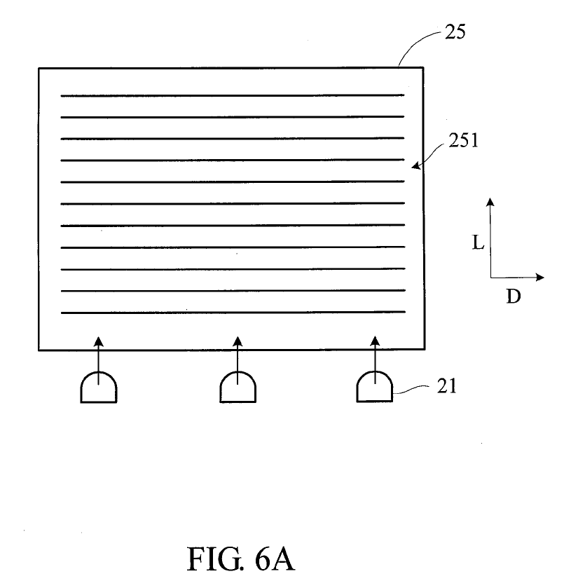

The preferred embodiment of the prism structure 251 of the present invention is depicted in FIG. 5A, with reference to FIG. 2 or FIG. 3. The prism structure 251 of this embodiment has a vertex angle θ, which ranges from about 55 to 70 degrees, and is preferably about 62 degrees. Other embodiments of the prism structure 251 are as depicted in FIG. 5B to FIG. 5E. The prism structure 251 may have variations in shape. For example, the prism structures 251 shown in FIG. 5B and FIG. 5C are asymmetric, but still have the preferred vertex angle ranging from 55 to 70 degrees. Alternatively, the prism structures 251 can have arc structures disposed sequentially or spaced apart from each other, as shown in FIG. 5D and FIG. 5E, instead of having the vertex angle. As described above, to adjust the angle of light, the prism structure 251 may be designed and modified depending on the actual requirements, or may be alternately formed with several kinds of structures.

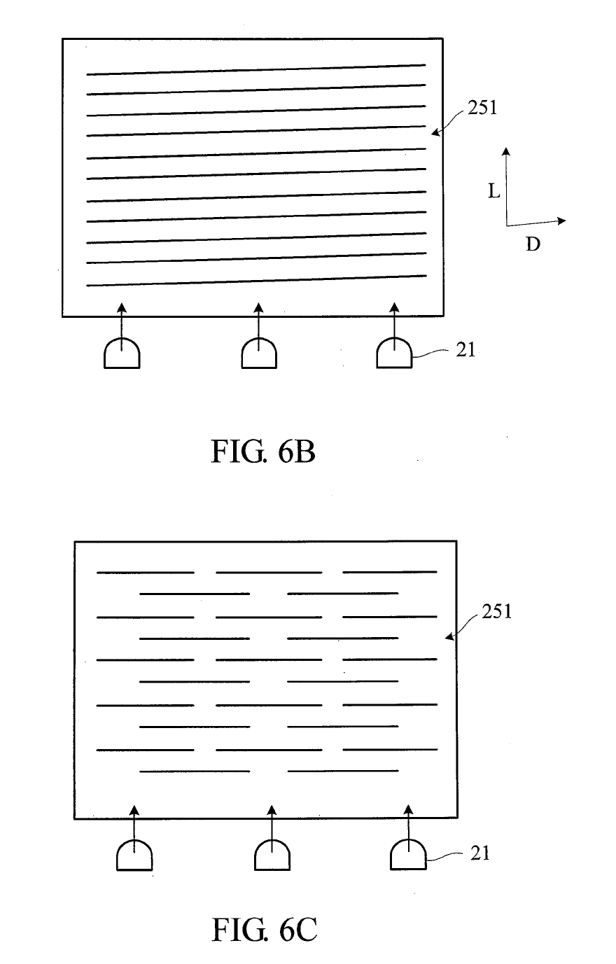

Additionally, the arrangement of the prism structures 251 may be further adjusted. As shown in FIG. 6A, the prism structures 251 are arranged in a sequence along the first direction D, which is preferably substantially perpendicular to the light traveling direction L. Alternatively, depending on the light collecting efficiency requirements of the final product, the included angle between the first direction D and the light traveling direction L is about 45 to 135 degrees, as shown in FIG. 6B. The prism structures 251 may also have an alternate arrangement as shown in FIG. 6C. The way to adjust and modify the prism structures 251 is apparent to those skilled in the art. As shown FIG. 6C, the prism structures 251 may be arranged uniformly and separately, for sure, the prism structure 251 may be arranged randomly, depending on the design rule.

Referring again to FIG. 3, the second surface 235 of the light guide plate 23 may have a plurality of V-shape grooves 237 or a coated atomizing layer. Both of these characteristics would interact with other optical elements that are subsequently formed to help improve the overall performance of the backlight module 20.

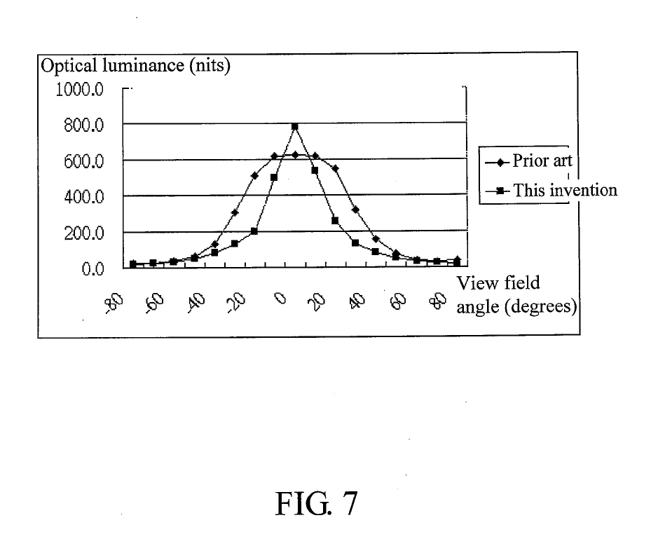

A luminance measurement (in nits) may be made on the backlight module 20 of the present embodiment, as shown in FIG. 7. FIG. 7 also shows a superior luminance performance. FIG. 7 shows the luminance graph of a prism structure 251 with a vertex angle of 62 degrees in this embodiment, and a comparison thereof with a graph of a conventional backlight module. It can be seen clearly that, with the design of the prism structure 251 of the present embodiment, the luminance graph tends to converge towards 0 degrees. That is, light provided by the backlight module 20 will concentrate in a direction perpendicular to the second surface 235. In reference to FIG. 2, even for a portion of light at a relatively large diffusing angle, the total reflection is also eliminated with the use of the structure disclosed in the embodiment of the present invention, so that the light may emit from the prism sheet 25 in a direction perpendicular to the second surface 235. As a result, the backlight module 20 of the present embodiment will have a more preferable luminance performance compared to the conventional backlight module under the same light source conditions.

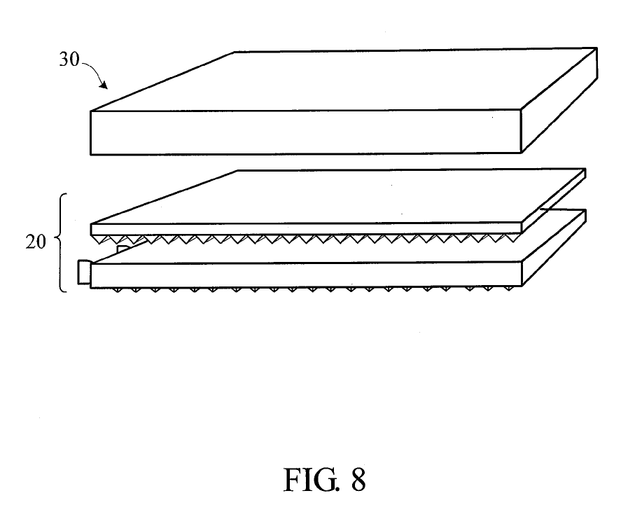

As illustrated in FIG. 8, the backlight module 20 of one embodiment of the present invention provides a surface light source with a superior light collecting efficiency for subsequent use in a liquid crystal panel 30. With the control of the pixels in the liquid crystal panel 30, the frame will be displayed in the panel for the user. More specifically, compared to that provided by a conventional backlight module, light provided by the backlight module 20 is more concentrated towards a direction perpendicular to the liquid crystal panel 30. It is conceivable that the user may experience a higher luminance under the same light source conditions.

As described above, the backlight module of the present invention comprises a plurality of prism structures that are formed on the prism sheet and face the light guide plate. These prism structures interact with a plurality of fly-cut patterns and other optical elements on the bottom surface of the light guide plate, so that light provided by the backlight module is concentrated towards a direction normal to the display panel. The luminance performance of the backlight module is thus, improved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A backlight module comprising:
a light guide plate having a first surface, a second surface opposite to the first surface, and a side;
a light source disposed adjacent to the side of the light guide plate; and
a prism sheet disposed adjacent to the second surface of the light guide plate, the prism sheet having a plurality of prism structures facing the light guide plate, wherein each of the prism structures has a vertex angle of about 55 to 70 degrees.

2. The backlight module as claimed in claim 1, wherein the first surface is formed with a plurality of fly-cut patterns.

3. The backlight module as claimed in claim 2, wherein the light source provides a light along a light traveling direction facing the side, and the plurality of fly-cut patterns are protrusions, each having a planar projection configured by a principal axis and a secondary axis perpendicular to the principal axis, in which the principal axis is substantially parallel to the light traveling direction, and wherein each of the protrusions has a semi-pit shape.

4. The backlight module as claimed in claim 2, wherein the light source provides a light along a light traveling direction facing the side, and the plurality of fly-cut patterns are protrusions, each having a planar projection configured by a principal axis and a secondary axis perpendicular to the principal axis, in which the principal axis is substantially parallel to the light traveling direction, and wherein the prism structures are sequentially disposed along a first orientation.

5. The backlight module as claimed in claim 4, wherein the first orientation is substantially perpendicular to the light traveling direction.

6. The backlight module as claimed in claim 4, wherein the first orientation and the light traveling direction are formed with an included angle of about 45 to 135 degrees.

7. The backlight module as claimed in claim 1, wherein the second surface of the light guide plate has a plurality of V-shape grooves formed thereon.

8. The backlight module as claimed in claim 1, wherein the second surface of the light guide plate has an atomizing layer.

9. The backlight module as claimed in claim 1, wherein the prism sheet is a reverse prism sheet.

10. The backlight module as claimed in claim 1, wherein the vertex angle is of about 62 degrees.

11. A liquid crystal display comprising:
a liquid crystal panel; and
the backlight module as claimed in claim 1, which is adjacent to the liquid crystal panel.

12. The liquid crystal display as claimed in claim 11, wherein the first surface is formed with a plurality of fly-cut patterns.

13. The liquid crystal display as claimed in claim 12, wherein the light source provides a light along a light traveling direction facing the side, and the plurality of fly-cut patterns are protrusions, each having a planar projection configured by a principal axis and a secondary axis perpendicular to the principal axis, in which the principal axis is substantially parallel to the light traveling direction.

14. The liquid crystal display as claimed in claim 13, wherein each of the protrusions has a semi-pit shape.

15. The liquid crystal display as claimed in claim 13, wherein the prism structures are sequentially disposed along a first orientation which is substantially perpendicular to the light traveling direction.

16. The liquid crystal display as claimed in claim 13, wherein the prism structures are sequentially disposed along a first orientation, in which the first orientation and the light traveling direction are formed with an included angle of about 45 to 135 degrees.

17. The liquid crystal display as claimed in claim 11, wherein the second surface of the light guide plate has a plurality of V-shape grooves or an atomizing layer formed thereon.

18. The liquid crystal display as claimed in claim 11, wherein the vertex angle is of about 62 degrees.

19. A backlight module comprising:
a light guide plate having a first surface, a second surface opposite to the first surface, and a side, wherein the first surface is formed with a plurality of fly-cut patterns;
a light source disposed adjacent to the side of the light guide plate; and
a prism sheet disposed adjacent to the second surface of the light guide plate, the prism sheet having a plurality of prism structures facing the light guide plate.

20. The backlight module as claimed in claim 19, wherein the light source provides a light along a light traveling direction facing the side, and the plurality of fly-cut patterns are protrusions, each having a planar projection configured by a principal axis and a secondary axis perpendicular to the principal axis, in which the principal axis is substantially parallel to the light traveling direction, and wherein each of the protrusions has a semi-pit shape.

21. The backlight module as claimed in claim 20, wherein the prism structures are sequentially disposed along a first orientation, and wherein the first orientation is substantially perpendicular to the light traveling direction.

22. The backlight module as claimed in claim 20, wherein the prism structures are sequentially disposed along a first orientation, and wherein the first orientation and the light traveling direction are formed with an included angle of about 45 to 135 degrees.

23. The backlight module as claimed in claim 19, wherein the second surface of the light guide plate has a plurality of V-shape grooves formed thereon

24. The backlight module as claimed in claim 19, wherein the second surface of the light guide plate has an atomizing layer.

25. The backlight module as claimed in claim 19, wherein the prism sheet is a reverse prism sheet.
